(19) United States
(12) Patent Application Publication
(10) Pub. No.: US 2025/0130857 A1
(43) Pub. Date: Apr. 24, 2025

(54) Methods, Systems and Computer Program Products for Resource Management for On-Demand Cloud Computing

(71) Applicant: Now.gg, Inc., Campbell, CA (US)

(72) Inventor: Rosen Sharma, Monte Sereno, CA (US)

(21) Appl. No.: 18/921,696

(22) Filed: Oct. 21, 2024

Related U.S. Application Data
(60) Provisional application No. 63/545,031, filed on Oct. 20, 2023.

(51) Int. Cl. G06F 9/50

(52) U.S. Cl. CPC G06F 9/5027

(57) ABSTRACT

The present invention relates to on-demand cloud computing. The invention includes (i) receiving a request for providing a first resource user access to a first set of cloud computing devices (ii) parsing data records corresponding to a second set of cloud computing devices. Each device within the second set of cloud computing devices is reserved for exclusive use by a dedicated capacity resource user, (iii) identifying a matched set of cloud computing devices that is a sub-set of the second set of cloud computing devices. Hardware resource attributes of the matched set of cloud computing devices match hardware resource attributes identified in the received request, (iv) retrieving access control credentials associated with each hardware device within the matched set of cloud computing devices, and (v) delivering a cloud computing service to the first resource user through the matched set of cloud computing devices.

### CROSS-REFERENCE TO RELATED APPLICATION

This application claims priority to U.S. Provisional Application No. 63/545,031 filed Oct. 20, 2023, the disclosure of which is hereby incorporated by reference in its entirety.

### BACKGROUND OF THE INVENTION

### Field of the Invention

The present invention relates to on-demand cloud computing. In particular, the present invention provides methods, systems and computer program products for resource management in on-demand cloud computing platforms, including providing, allocating and enabling use of data processing resources in on-demand cloud computing platforms.

### Description of Related Art

Development of cloud-based computing platforms has enabled fast, convenient and scalable deployment of web-based software services and solutions without the need for investment in a permanent or dedicated hardware resource pool. Cloud computing platforms are configured to deploy a set of hosted resources such as computing devices or systems processors, operating systems, software and other components that can be combined together to form virtual machines. A user of an on-demand cloud computing platform can request instantiation of one or more virtual machines from the hosted resources, via a cloud computing platform management system, and can utilize the instantiated virtual machine(s) to perform one or more tasks or applications. For example, a user of an on-demand cloud computing platform may wish to set up and instantiate a virtual server from the cloud to create a platform for online gaming where computer games are executed on hosted data processing resources, and video and audio output from the hosted computer games is streamed to one or more remote terminals through which gamers are accessing or playing the hosted computer games. The user of the on-demand cloud computing platform can accordingly lease or subscribe to the set of resources needed to build and run the set of instantiated virtual machines on a long term-basis (e.g. weeks or months), or on a short-term basis (e.g. hours or days or minutes), for executing a desired software application(s).

Various providers offer on-demand cloud computing platforms including, for example, Amazon's “EC2”, Microsoft Azure, and Rackspace Cloud. Resources from these providers can be made available as on-demand resources, and the pricing for securing on-demand resources can vary significantly depending on the parameters of the on-demand resource request and the scarcity of available resources at the time the request is made. For example, advance reservation of cloud computing resources for a large set of computing resources over long duration (e.g. for an uninterrupted duration of six months) is likely to be relatively cheaper (per unit time) than a real-time demand for a small set of duration guaranteed computing resources (i.e. computing resources whose availability is guaranteed by the computing platform for the entire requested duration) that are only required for a few minutes or a few hours, as the service provider would have to respond to a real-time demand for the duration guaranteed computing resources out of a smaller pool of resources that are available for allocation at the time the real-time demand is made—which results in a higher per-unit price. The higher price in such cases is a result of the service provider having to instantly secure for the requesting entity a set of computing resources for a fixed duration (corresponding to the duration specified in the request) out of a finite/limited pool of available computing resources, for which the demand would naturally be higher than in the case of advance reservation.

One solution, to on-demand price spikes, that is offered by some providers of on-demand cloud computing, is to offer “spot instances” of cloud based computing resources—where spot instances are typically made available only until another customer is willing to pay more for the instance, for example, the prevailing spot instance price exceeds a customer's maximum bid. The spot prices (per unit time) may be lower than prices for advance reservation of computing resources and/or for on-demand requests for duration guaranteed computing resources. Certain forms of spot instances offer an initial “safe” period at additional cost. However, regardless of the safe period, spot instances remain at risk of forced deallocation (i.e. a “spot kill” or a “spot pre-emption”) over time.

There is accordingly a need for a solution that enables identification and provision of on-demand computing resources in response to real-time demand at predictable pricing, and with a lower risk of a forced deallocation in situations where the hosted resources of a cloud computing platform are facing high demand/peak demand.

### SUMMARY OF THE INVENTION

The invention provides methods, systems and computer program products for resource management in on-demand cloud computing platforms. In particular, the invention enables identification of, provisioning of, allocation of, and/or enabling use of, data processing resources in on-demand cloud computing platforms.

The invention provides a computer implemented method for resource management for on-demand cloud computing. In an embodiment, the method comprises the steps of (i) receiving at a resource sharing platform, a request for providing to a first resource user, access to a first set of cloud computing hardware devices for communication network based delivery of at least one cloud computing service to the first resource user, wherein the request received at the resource sharing platform includes (a) a first set of hardware resource attributes that are required in the first set of cloud computing hardware devices, and (b) a first defined period of time for which access to the first set of cloud computing hardware devices is requested, (ii) parsing data records that are retrievably stored by the resource sharing platform, and that correspond to a second set of cloud computing hardware devices, wherein each hardware device within the second set of cloud computing hardware devices (c) is controllable by a cloud computing platform for instantiating or operating one or more virtual machine processes for communication network based delivery of one or more cloud computing services, (d) is reserved for exclusive use by a dedicated capacity resource user, for a second defined period of time, wherein the dedicated capacity resource user is distinct from the first resource user, and (e) is identified within at least one data record within the data records that are retrievably stored by the resource sharing platform, as being available for access by resource users other than the dedicated capacity resource user, within a third defined period of time that is a sub-set of the second defined period of time, (iii) identifying based on the parsed data records, a matched set of cloud computing hardware devices that is a sub-set of the second set of cloud computing hardware devices, wherein (f) hardware resource attributes of the matched set of cloud computing hardware devices match the first set of hardware resource attributes identified in the request received at the resource sharing platform, and (g) for each hardware device within the matched set of cloud computing hardware devices, at least part of the first defined period of time identified in the request received at the resource sharing platform falls within the third defined period of time during which said hardware device has been identified as being available for access by resource users other than the dedicated capacity resource user corresponding to said hardware device, (iv) retrieving cloud computing access control credentials associated with each hardware device within the matched set of cloud computing hardware devices, wherein said cloud computing access control credentials enable access to said hardware device through the cloud computing platform, and (v) delivering to the first resource user over the communication network, the at least one cloud computing service, wherein delivery of the at least one cloud computing service includes (h) instantiating or operating at least one virtual machine process on the matched set of cloud computing hardware devices, and (i) transmitting output from the at least one virtual machine process to a receiving computing device associated with the first resource user.

The invention additionally provides a system for resource management for on-demand cloud computing. The system comprises a memory, and a processor implemented resource sharing platform, configured for (i) receiving at a resource sharing platform, a request for providing to a first resource user, access to a first set of cloud computing hardware devices for communication network based delivery of at least one cloud computing service to the first resource user, wherein the request received at the resource sharing platform includes (a) a first set of hardware resource attributes that are required in the first set of cloud computing hardware devices, and (b) a first defined period of time for which access to the first set of cloud computing hardware devices is requested, (ii) parsing data records that are retrievably stored by the resource sharing platform, and that correspond to a second set of cloud computing hardware devices, wherein each hardware device within the second set of cloud computing hardware devices (c) is controllable by a cloud computing platform for instantiating or operating one or more virtual machine processes for communication network based delivery of one or more cloud computing services, (d) is reserved for exclusive use by a dedicated capacity resource user, for a second defined period of time, wherein the dedicated capacity resource user is distinct from the first resource user, and (e) is identified within at least one data record within the data records that are retrievably stored by the resource sharing platform, as being available for access by resource users other than the dedicated capacity resource user, within a third defined period of time that is a sub-set of the second defined period of time, (iii) identifying based on the parsed data records, a matched set of cloud computing hardware devices that is a sub-set of the second set of cloud computing hardware devices, wherein (f) hardware resource attributes of the matched set of cloud computing hardware devices match the first set of hardware resource attributes identified in the request received at the resource sharing platform, and (g) for each hardware device within the matched set of cloud computing hardware devices, at least part of the first defined period of time identified in the request received at the resource sharing platform falls within the third defined period of time during which said hardware device has been identified as being available for access by resource users other than the dedicated capacity resource user corresponding to said hardware device, (iv) retrieving cloud computing access control credentials associated with each hardware device within the matched set of cloud computing hardware devices, wherein said cloud computing access control credentials enable access to said hardware device through the cloud computing platform, and (v) delivering to the first resource user over the communication network, the at least one cloud computing service, wherein delivery of the at least one cloud computing service includes (h) instantiating or operating at least one virtual machine process on the matched set of cloud computing hardware devices, and (i) transmitting output from the at least one virtual machine process to a receiving computing device associated with the first resource user.

The invention additionally provides a computer program product for resource management for on-demand cloud computing. The computer program product comprises a non-transitory computer readable medium having a computer readable program code embodied therein, the computer readable program code comprising instructions for implementing the steps of (i) receiving at a resource sharing platform, a request for providing to a first resource user, access to a first set of cloud computing hardware devices for communication network based delivery of at least one cloud computing service to the first resource user, wherein the request received at the resource sharing platform includes (a) a first set of hardware resource attributes that are required in the first set of cloud computing hardware devices, and (b) a first defined period of time for which access to the first set of cloud computing hardware devices is requested, (ii) parsing data records that are retrievably stored by the resource sharing platform, and that correspond to a second set of cloud computing hardware devices, wherein each hardware device within the second set of cloud computing hardware devices (c) is controllable by a cloud computing platform for instantiating or operating one or more virtual machine processes for communication network based delivery of one or more cloud computing services, (d) is reserved for exclusive use by a dedicated capacity resource user, for a second defined period of time, wherein the dedicated capacity resource user is distinct from the first resource user, and (e) is identified within at least one data record within the data records that are retrievably stored by the resource sharing platform, as being available for access by resource users other than the dedicated capacity resource user, within a third defined period of time that is a sub-set of the second defined period of time, (iii) identifying based on the parsed data records, a matched set of cloud computing hardware devices that is a sub-set of the second set of cloud computing hardware devices, wherein (f) hardware resource attributes of the matched set of cloud computing hardware devices match the first set of hardware resource attributes identified in the request received at the resource sharing platform, and (g) for each hardware device within the matched set of cloud computing hardware devices, at least part of the first defined period of time identified in the request received at the resource sharing platform falls within the third defined period of time during which said hardware device has been identified as being available for access by resource users other than the dedicated capacity resource user corresponding to said hardware device, (iv) retrieving cloud computing access control credentials associated with each hardware device within the matched set of cloud computing hardware devices, wherein said cloud computing access control credentials enable access to said hardware device through the cloud computing platform, and (v) delivering to the first resource user over the communication network, the at least one cloud computing service, wherein delivery of the at least one cloud computing service includes (h) instantiating or operating at least one virtual machine process on the matched set of cloud computing hardware devices, and (i) transmitting output from the at least one virtual machine process to a receiving computing device associated with the first resource user.

### BRIEF DESCRIPTION OF THE DRAWINGS

FIG. 1 illustrates a system environment of a kind that may be used to implement resource management in on-demand cloud computing platforms in accordance with the teachings of the present invention.

FIG. 2 illustrates categories of users of hosted resources within a cloud computing platform.

FIG. 3 illustrates an embodiment of the cloud computing platform management system that is more generally illustrated in FIG. 1.

FIG. 4 illustrates a flowchart showing a for enabling resource user(s) to make available or to onboard their dedicated resource(s) at a dedicated resource sharing platform.

FIG. 5 illustrates an example of a data structure of a type that is described in connection with the method of FIG. 4.

FIG. 6 illustrates a flowchart showing a method for enabling dedicated resources that have been reserved to a first resource user, to be used for providing cloud computing services to a second resource user who is different from the first resource user.

FIG. 7 illustrates an embodiment of the dedicated resource sharing platform that is more generally illustrated in FIG. 1.

FIG. 8 illustrates an exemplary system for implementing the present invention.

### DESCRIPTION OF THE INVENTION

The invention provides methods, systems and computer program products for resource management in on-demand cloud computing platforms. In particular, the invention enables identification of, provisioning of, allocation of, and/or enabling use of, data processing resources in on-demand cloud computing platforms.

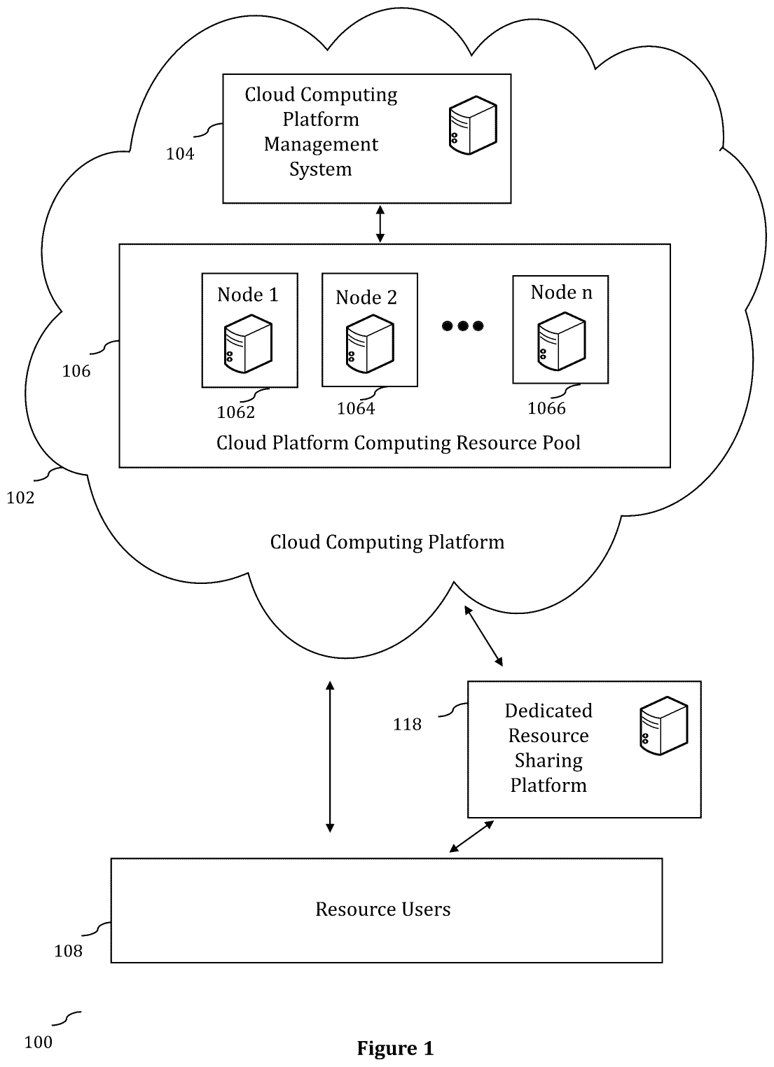

The invention may be implemented within a cloud computing environment 100 of a kind illustrated in FIG. 1.

FIG. 1 illustrates a cloud computing environment 100, in which systems and methods for resource management in on-demand cloud computing platforms can operate, according to embodiments of the present invention. The embodiments described in this written description can be implemented in or supported by a cloud network architecture. For the purposes of the present invention, a “cloud” can comprise a collection of resources that can be invoked to instantiate a virtual machine, process, or other resource for a defined duration or a limited duration. As shown for example in FIG. 1, cloud computing environment 100 comprises cloud computing platform 102, dedicated resource sharing platform 118 and resource users 108.

Cloud computing platform 102 comprises cloud computing management system 104 and cloud platform computing resource pool 106. Cloud platform computing resource pool 106 comprises a set of nodes—the set of nodes comprising nodes 1 to n (1062, 1064, 1066)—wherein each node comprises a computing device or server or a set of computing components, that is configured to deliver or make available one or more computing components required to instantiate or operate a virtual machine process or other resource that is required for implementing a cloud computing service for a user of cloud computing platform 102. By way of example, (i) a set of one or more nodes can host and serve an operating system (or parts of an operating system) to instantiate and deliver a virtual machine, (ii) a set of one or more nodes (i.e. the same or a different set) can accept requests to host computing cycles or processor time, to supply a required capability of processing functionality to a virtual machine, (iii) a set of one or more nodes (i.e. the same or a different set) can host and serve applications to load on an instantiation of a virtual machine.

In embodiments, the set of nodes 106 as well as other hardware or software resources that are used to implement or operate cloud computing platform 102 and the instantiated virtual machines within cloud computing platform 102 are managed by cloud computing platform management system 104. The cloud computing platform management system 104 can comprise a server and/or other software, hardware, and network tools that communicate via one or more networks such as the Internet or other public or private networks with all nodes 1062 to 1066 to manage and control cloud computing platform 102 and its operation.

Cloud computing platform management system 104 is configured such that, for instantiating a new virtual machine, or for initiating a cloud computing session with one or more nodes 1062 to 1066 within cloud computing platform 102, a resource user (for example, a resource user from within the set of resource users 108) can transmit a virtual machine instantiation request or a cloud computing session request to cloud computing platform management system 104. In specific embodiments, the request may specify information regarding the particular type of virtual machine or cloud session that is requested and/or the required functionality or end-use application. Cloud computing platform management system 104 receives the request, and processes the request by identifying the type of virtual machine, process, session or other resource being requested. Cloud computing platform management system 104 is configured to identify the collection of nodes necessary to instantiate that machine, session or resource.

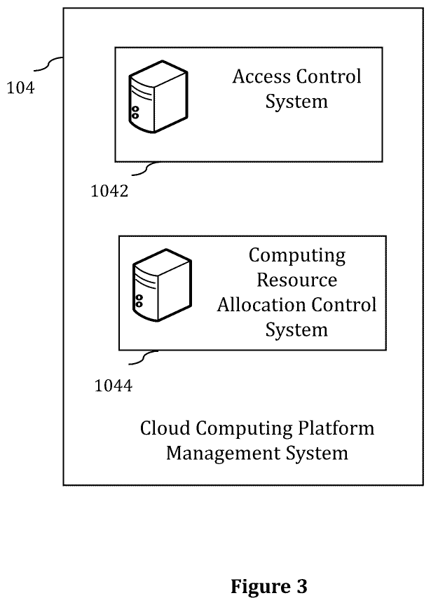

As shown in FIG. 3, cloud computing resource allocation control system 104 may comprise an access control system 1042 and a computing resource allocation control system 1044. Access control system 1042 is a processor implemented system configured to retrievably store, track and manage identity data or identity credentials and/or profile information corresponding to resource users—which enables determination of a requesting resource user's identity and an associated set of rights or entitlements or accesses that the resource user is entitled to avail within cloud computing platform 102. Computing resource allocation control system 1044 is a processor implemented system that is configured to respond to a resource user's request for instantiation of a virtual machine(s) or a cloud computing session(s) or other cloud based or virtual resource(s), by determining availability of cloud computing nodes or cloud computing resources necessary to instantiate the requested virtual machine(s), cloud computing session(s) and/or other cloud based or virtual resource(s), by assigning the necessary cloud computing nodes or cloud computing resources to the requesting resource user for the requested instantiation and subsequent operation. The assignment of cloud computing nodes or cloud computing resources to the requesting resource user may be subject to availability (and optionally subject to agreement on pricing) of the necessary cloud computing nodes or cloud computing resources.

A resource user's instantiation request (for a virtual machine(s) or a cloud computing session(s) or other cloud based or virtual resource(s)) can specify a variety of parameters defining the operation of virtual machine(s) or session(s) or resource(s) that are being requested. By way of example, the instantiation request can specify a defined period of time for which the instantiated machine or session is needed. The period of time can be, for example, an hour, a day, or other duration or increment of time. In embodiments, the resource user's instantiation request can specify the instantiation of virtual machine(s) or session(s) or process(es) on a task basis, rather than for a predetermined amount of time. For example, a user could request provision of a defined set of nodes within cloud computing platform 102 for the purpose of executing one or more computing tasks, until the one or more computing tasks are completed. The resource user's instantiation request may specify other parameters that define the configuration and operation of the requested virtual machine(s) or session(s) or other instantiated resource(s). For example, the request can specify a required amount of processing power, or a required input/output (I/O) throughput, or a required number of data processing units (DPUs) and/or a required number of graphics processing units (GPUs) that the resource user requires to be made available to an instance of the virtual machine, or to the instantiated session, or the other instantiated resource(s). The resource user's request can include any of the above parameters, or any other parameters not specifically mentioned, or combinations thereof.

Subsequent to receiving the resource user's request(s), computing resource allocation control system 1044 identifies the necessary nodes or other resources required to instantiate the requested virtual machine(s), session(s) and or other requested resource(s). Computing resource allocation control system 1044 communicates with one or more nodes 1062 to 1066 within cloud computing platform 102 to request and to secure or reserve the required computing nodes or computing components. The computing resource allocation control system 1044 can select multiple nodes to combine and/or assemble the various computing components required to provide the requested virtual machine(s) or session(s) or other resource(s). In particular embodiments, hardware, software or other resources not strictly located or hosted within cloud computing platform 102 can be accessed and/or reserved as needed by computing resource allocation control system 1044, for the purposes of responding to the resource user's request. For example, software services that are provided outside of the cloud computing platform 102 and that are hosted by third parties can be invoked by the instantiated virtual machine(s) or session(s), and/or other non-cloud hardware and/or storage services can be utilized as an extension to the computing platform 102.

Once the necessary resources have been identified cloud computing platform management system 104 instantiates the requested virtual machine(s) or session(s) or other resource(s) based on the identified resources.

In responding to a requested virtual machine(s) or session(s) or other resource(s), cloud computing platform management system 104 may require (through access control system 1042) to store, track and manage identity data or identity credentials and/or profile information corresponding to resource users—which enables determination of a requesting resource user's identity and an associated set of rights or entitlements or accesses that the resource user is entitled to avail within cloud computing platform 102. This enables cloud computing platform management system 104 to decide on various access related issues, including without limitation, any one or more of whether a resource user's request is an authorized request and requires to be responded to, whether the resources or accesses requested by the resource user are in fact permitted to the requesting resource user under the policy(ies) associated with that requesting resource user, specific actions that the requesting resource user is permitted to request or perform, and/or pricing that is to be applied to the resource user's request.

The instantiated virtual machine(s), session(s) and/or other resource(s) are then made available to the requesting resource user through one or more communication networks (for example, the Internet or any other data network or internetwork).

Resource users 108 shown in FIG. 1 comprises a set of resource users that request or are entitled to request the services of, or resources from, cloud computing platform 102. In certain embodiments, resource users may require to be onboarded with cloud computing platform management system 104 before they are permitted to request and/or receive cloud computing resources from cloud computing platform 102.

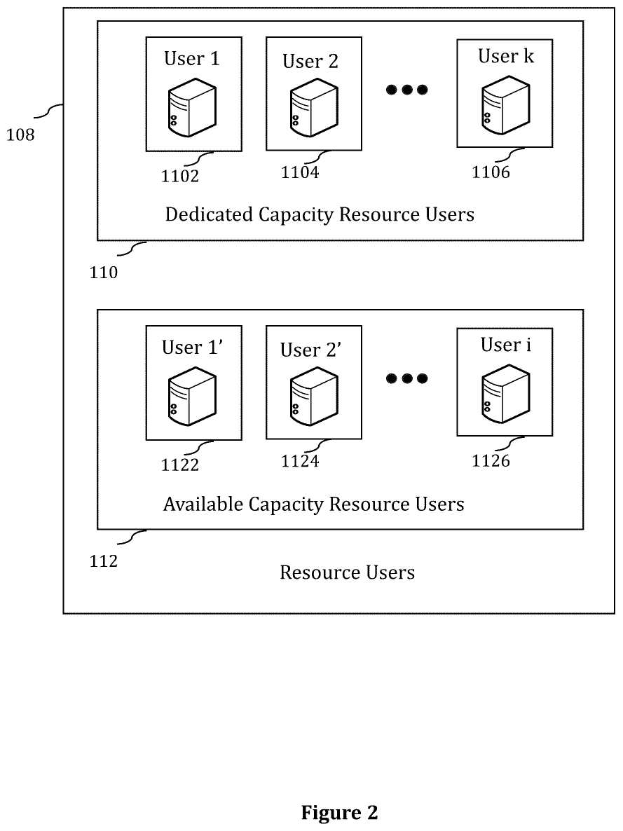

As shown in FIG. 2, resource users 108 may comprise (i) dedicated capacity resource users 110, comprising users 1, 2 upto to k (1102 to 1106), and (ii) available capacity resource users 112, comprising users 1′, 2′ upto i (1122 to 1126).

Dedicated capacity resource users 110 (also referred to as reserved capacity users) are resource users that have obtained dedicated and/or reserved amounts of computing nodes or resources within cloud computing platform 102. Since there is typically a finite capacity for each type of computing resource within a cloud computing platform 102, such platforms enable resource users to reserve defined capacity (i.e. a defined set of computing resources or nodes) within the cloud computing platform for specified periods of time—and in which case, the computing platform 102 may reserve this capacity exclusively for that resource user within the specified periods of time. The dedicated capacity remains reserved to such resource user regardless of whether the resource user actually needs or uses the dedicated capacity during the specified period. While reserving dedicated capacity within cloud computing platform 102 results in a predictable per-unit-time spend towards the reserved resource(s), this often result in unused excess capacity, as the concerned resource user typically must purchase enough dedicated capacity to handle periods of peak usage, even though the periods of peak usage may be infrequent. Despite not requiring the entire dedicated capacity all the time, the resource user still pays for this excess dedicated capacity.

Reserving dedicated capacity within cloud computing platform 102 involves defining the parameters of the dedicated capacity that is being reserved. Information regarding dedicated capacity associated with each resource user is stored by cloud computing platform management system 104 in data records associated with such resource user. When a dedicated capacity resource user 108 transmits a request for initiating a virtual machine(s) or cloud session(s) or other resource(s) within cloud computing platform 102, computing platform management system 104 retrieves information regarding dedicated capacity associated with that resource user from its records (for example, records associated with login credentials or profile data associated with the requesting resource user), and initiates the requested virtual machine(s) or cloud session(s) or other resource(s) within cloud computing platform 102 based on the dedicated capacity that has been reserved to such resource user.

Available capacity resource users 112 (i.e. resource users who request allocation of computing resources through real-time/on-demand requests) on the other hand obtain cloud computing resources from cloud computing platform on an “availability” basis, in response to a demand based in real time. Requests for a cloud computing node or resource qualifies as a request for “available capacity” where a requesting resource user does not have reserved dedicated capacity, or has exceeded its reserved dedicated capacity, or is requesting a cloud computing resource which is not included within its reserved dedicated capacity with the cloud computing platform 102. In such cases, cloud computing platform management system 104 ascertains whether the cloud computing platform 102 has available computing resources that can be used to meet the request—and subject to availability, and also subject to agreement to the pricing for such computing resources, allocates the available resources to service the request raised by the available capacity resource user. Since requests for available capacity are received and processed in real time, several different resource users may be simultaneously competing for a finite set of available resources, and as a result such resources can be significantly more expensive, especially during peak demand. There may additionally be situations where due to high demand or peak demand for specific types of nodes or cloud computing resources, cloud computing platform 102 may not have a sufficient number of the necessary nodes or cloud computing resources—resulting in a denial of service to one or more resource users who have requested that type of node or cloud computing resource.

The invention optimizes resource management within cloud computing platform 102 through dedicated resource sharing platform 118. Dedicated resource sharing platform 118 comprises a processor implemented, or server implemented, or computing device implemented, platform that is configured to track dedicated resources within cloud computing platform 102 and parameter information and/or state information corresponding to such dedicated resources.

The term “dedicated resource(s)” may be understood as referring to dedicated and/or reserved computing nodes or computing components or cloud computing resources within cloud computing platform 102 that have been reserved by one or more resource users for specified periods of time—and which are therefore reserved exclusively for such resource user(s) within the specified periods of time.

Dedicated resource sharing platform 118 may be located within cloud computing platform 102, or alternatively may be external to cloud computing platform 102 and may be configured to communicate with cloud computing platform 102 (for example through cloud computing platform management system 104). As explained in detail below, dedicated resource sharing platform 118 is configured to respond to a request from a resource user, for instantiation of one or more virtual machine(s), or a cloud computing session(s) or other cloud based or virtual resource(s) such as nodes or computing components within cloud computing platform 102, by checking the status of dedicated resources within cloud computing platform 102 to ascertain whether any of the dedicated resources are currently unused or unutilized or under utilized—and to thereafter communicate with cloud computing platform 102 (or with cloud computing platform management system 104) to assign the unused or unutilized or under utilized dedicated resources to the requesting resource user for the purposes of instantiating the requested one or more virtual machine(s), cloud computing session(s) or other cloud based or virtual resource(s). In particular embodiments of the invention, dedicated resource sharing platform 118 is configured such that it can only ascertain status and/or initiate assignment of dedicated resources/reserved resources that have been volunteered for sharing by the respective dedicated capacity resource user(s) to whom said resources have been dedicated, and more preferably only for specific periods where such dedicated capacity resource user(s) have specifically consented to sharing of their dedicated resources or have onboarded their dedicated resource(s) at dedicated resource sharing platform 118 for sharing with other resource users.

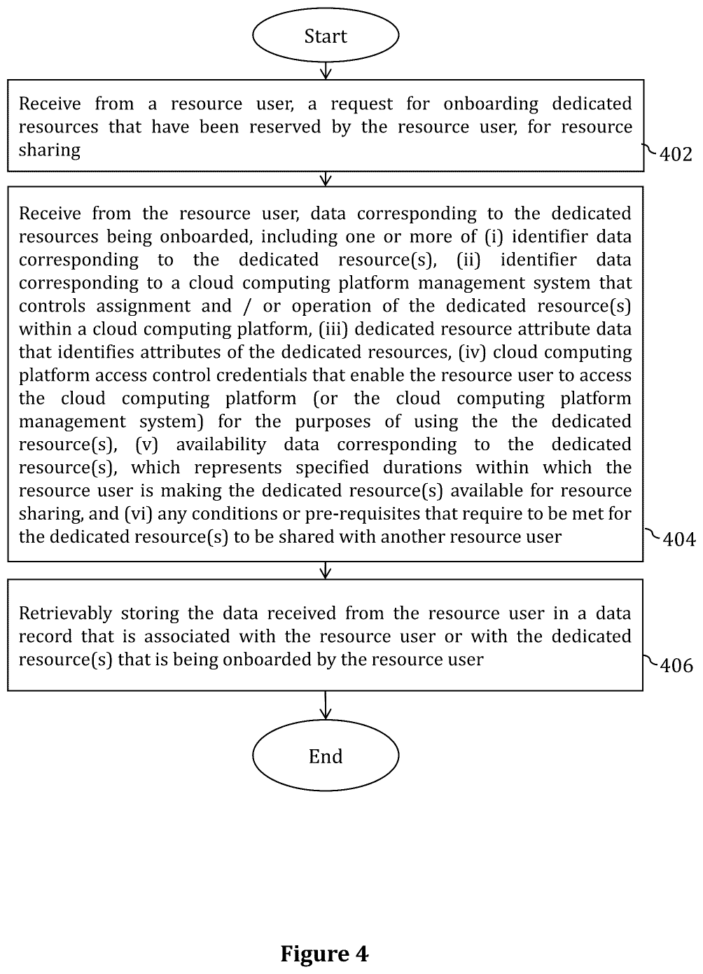

FIG. 4 illustrates an exemplary method for enabling resource user(s) to make available or to onboard their dedicated resource(s) at dedicated resource sharing platform 118, for sharing with other resource users. In an embodiment, the method of FIG. 4 is implemented at dedicated resource sharing platform 118.

Step 402 comprises receiving from a resource user (or from a computing terminal or computing device operated or controlled by a resource user), a request for onboarding one or more dedicated resources that have been reserved by the resource user at a cloud computing platform 102, for the purposes of resource sharing or for making such dedicated resources available for use by other resource users. The dedicated resource sharing platform 118 may in an embodiment respond to the request by initiating an onboarding workflow for making the identified dedicated resources available for sharing with other resource users through dedicated resource sharing platform 118.

Step 404 comprises receiving from the resource user (or from the computing terminal or computing device operated or controlled by the resource user), data corresponding to the dedicated resources that are intended to be shared or onboarded by the resource user. In an embodiment, the received data may include any one or more of:
identifier data corresponding to the dedicated resource(s). In an embodiment the identifier data corresponding to the dedicated resource(s) may include any one or more of unique identifier data associated with the dedicated resource(s), address data or network address associated with the dedicated resource(s) which enables data communication with the dedicated resource(s), unique identifier data associated with a cloud computing platform 102 of which the dedicated resource(s) form a part, and address data or network address associated with the cloud computing platform 102 (of which the dedicated resource(s) form a part) which enables data communication with said cloud computing platform 102.
identifier data corresponding to a cloud computing platform management system 104 that controls assignment and/or operation of the dedicated resource(s) within the cloud computing platform 102. In an embodiment the identifier data corresponding to the cloud computing platform management system 104 may include any one or more of unique identifier data associated with the cloud computing platform management system 104, and/or address data or network address associated with the cloud computing platform management system 104 and which enables data communication with the cloud computing platform management system 104.
cloud computing platform access control credentials that enable the resource user to access the cloud computing platform 102 (or the cloud computing platform management system 104) for the purposes of accessing, using, or requesting the use of the dedicated resource(s). In an embodiment, the access control credentials may include a login id, and/or one or more of password data, passcode data, or any secret data that can be used for identity authentication of the resource user.
availability data corresponding to the dedicated resource(s). The availability data represents specified durations within which the resource user is making the dedicated resource(s) available for resource sharing. In an example, the availability data may specify time periods during which the resource user has no need for the dedicated resource(s)—for example, for periods outside regular working hours and/or on weekends and holidays.
any conditions or pre-requisites that require to be met for the dedicated resource(s) to be shared with another resource user. These conditions may comprise any conditions or pre-requisites that may be associated with sharing of the dedicated resource(s) with other resource user(s)—and for example may include pricing requirements, non-compete requirements, or any requirements that the resource user (who is making the dedicated resource(s) available for sharing) or the cloud computing platform 102 or the cloud computing platform management system 104 may specify.

Step 406 comprises retrievably storing the data received from the resource user (at step 404) in a data record that is associated with the resource user or with the dedicated resource(s) that is being onboarded for sharing by the resource user.

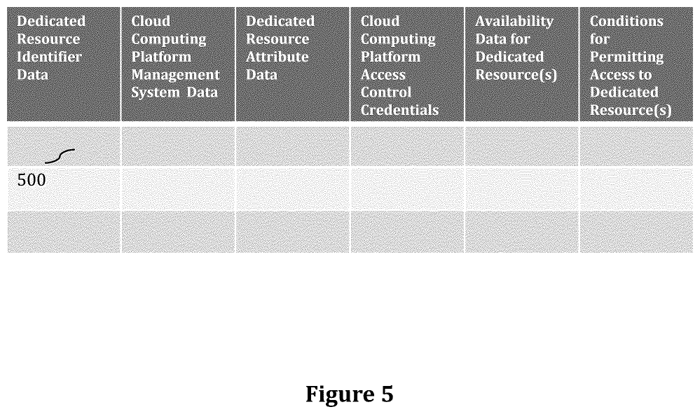

FIG. 5 illustrates an exemplary data structure 500 that may be used for storing data records of a type that are generated and stored at step 406. In the exemplary embodiment, data structure 500 has data fields corresponding to each of the data elements described in connection with step 404. However, it would be understood that data structure 500 may include other fields as well, and/or may omit one or more of the data fields that are currently shown.

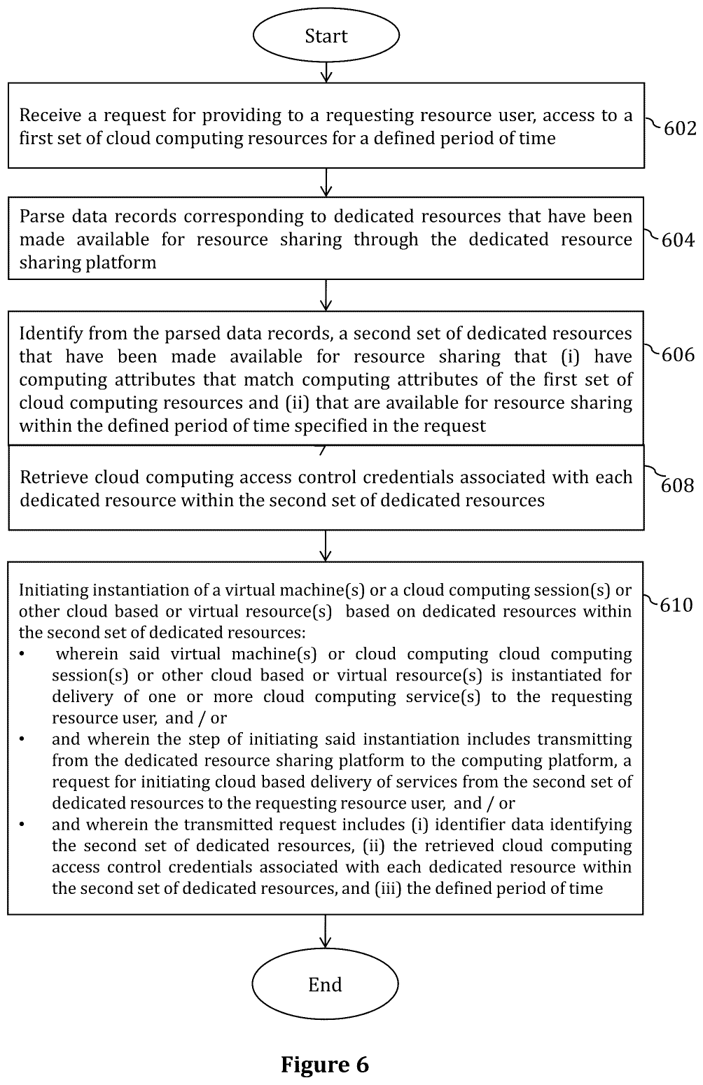

FIG. 6 illustrates a method for enabling dedicated resources that have been reserved to a first resource user by cloud computing platform 102, to be used for providing cloud computing services to a second resource user who is different from the first resource user. In an embodiment, the method of FIG. 6 may be implemented at or through dedicated resource sharing platform 118.

Step 602 comprises receiving a request for providing to a requesting resource user, access to a first set of cloud computing resources for a defined period of time. In an embodiment, the request may be transmitted to dedicated resource sharing platform 118 by the requesting resource user, or by an application program implemented on a computing terminal operated or controlled by the requesting resource user. In another embodiment, the request may be received by and thereafter redirected to dedicated resource sharing platform 118 by cloud computing platform 102 or by cloud computing platform management system 104, in response to a determination that the cloud computing platform 102 does not have sufficient nodes or other computing components that are available to meet the requesting resource user's request for a first set of cloud computing resources.

Step 604 comprises parsing data records corresponding to dedicated resources that have been made available for resource sharing through the dedicated resource sharing platform 118. In an embodiment, the parsed data records include one or more of the data fields shown in the exemplary data structure of FIG. 5. In an embodiment, the data records are parsed by dedicated resource sharing platform 118 with a view to identify dedicated resources that have been onboarded at dedicated resource sharing platform 118 (by resource user(s) to whom the dedicated resources have been reserved, for sharing with other resource users) that can be used to meet the requesting resource user's request for a first set of cloud computing resources.

Step 606 comprises identifying from the parsed data records, a second set of dedicated resources that have been made available for resource sharing and that (i) have computing attributes that match computing attributes of the first set of cloud computing resources and (ii) that are available for resource sharing within the defined period of time specified in the request. In an embodiment, the identification of data records at step 606 is implemented by dedicated resource sharing platform 118 as a result of the parsing at step 604.

Thereafter, step 608 comprises retrieving cloud computing access control credentials associated with each dedicated resource within the second set of dedicated resources. The access control credentials may comprise credentials or data that enables a resource user to access, control or operate the respective dedicated resource(s). In an embodiment, the access control credentials may comprise credentials or data that enables a resource user to access, control or operate the dedicated resource(s) through a cloud computing platform 102 or a cloud computing platform management system 104 at which the dedicated resource(s) is located/associated or controlled. In an embodiment, the retrieved access control credentials corresponding to each dedicated resource within the second set of dedicated resources may include a login id, and/or one or more of password data, passcode data, or any secret data or first or second factor authentication data that can be used for identity authentication of the resource user.

Step 610 comprises initiating (directly, or through a computing platform within which the second set of dedicated resources are located, or through any other computing platform or device), instantiation of a virtual machine(s) or a cloud computing cloud computing session(s) or other cloud based or virtual resource(s) based on dedicated resources within the second set of dedicated resources.

In embodiment of step 610:
said virtual machine(s) or cloud computing cloud computing session(s) or other cloud based or virtual resource(s) is instantiated for delivery of one or more cloud computing service(s) to the requesting resource user,
and/or the step of initiating said instantiation includes transmitting from the dedicated resource sharing platform to a computing platform (for example a cloud computing platform 102 or a cloud computing platform management system 104 or directly to one or more dedicated resources), a request for initiating cloud based delivery of services from the second set of dedicated resources to the requesting resource user,
and/or wherein the transmitted request includes (i) identifier data identifying the second set of dedicated resources, (ii) the retrieved cloud computing access control credentials associated with each dedicated resource within the second set of dedicated resources, and (iii) the defined period of time (i.e. the defined period of time specified within the request received at step 602).

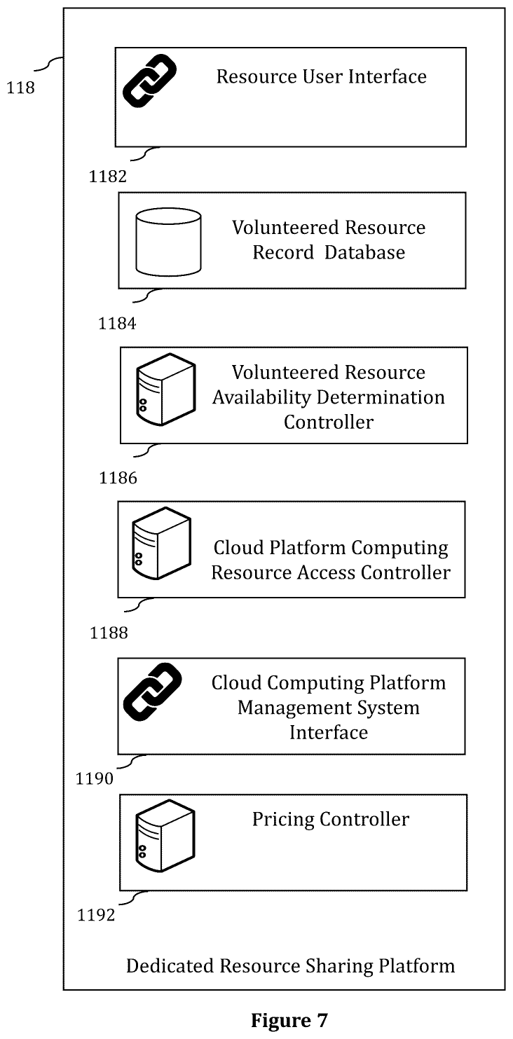

FIG. 7 illustrates an embodiment of the dedicated resource sharing platform 118 that is more generally illustrated in FIG. 1. As described above, dedicated resource sharing platform 118 comprises a processor implemented, or server implemented, or computing device implemented platform that is configured to track dedicated resources within cloud computing platform 102 and parameter information and/or state information corresponding to such dedicated resources.

Dedicated resource sharing platform 118 includes a processor implemented resource user interface 1182 that enables one or more resource users to interface with dedicated resource sharing platform 118 and to communicate with said platform. Resource users may interface with dedicated resource sharing platform 118 for the purposes of volunteering dedicated resources for sharing, or for the purposes of requesting access to one or more dedicated resources that have been volunteered for sharing.

Dedicated resource sharing platform 118 includes a volunteered resource record database 1184 that stores data records corresponding to dedicated resources that have been onboarded for sharing through the platform 118 (for example, through the method of FIG. 4). In an embodiment the data records stored at database 1184 may comprise a data record having a data structure 500 of the type illustrated and/or described in connection with FIG. 5.

Dedicated resource sharing platform 118 also includes a volunteered resource availability determination controller 1186. Volunteered resource availability determination controller 1186 is a processor implemented controller that is configured to implement a part or whole of one or more of method steps 604 and 606 of FIG. 6—i.e. to respond to a received request for providing to a requesting resource user, access to a first set of cloud computing resources for a defined period of time by (i) parsing data records corresponding to dedicated resources that have been made available for resource sharing through the dedicated resource sharing platform 118 and/or (ii) identifying from the parsed data records, a second set of dedicated resources that have been made available for resource sharing that (a) have computing attributes that match computing attributes of the first set of cloud computing resources and/or (b) that are available for resource sharing within the defined period of time specified in the request.

Dedicated resource sharing platform 118 also includes a cloud platform computing resource access controller 1188. Cloud platform computing resource access controller 1188 is a processor implemented controller that is configured to implement a part or whole of method step 608 of FIG. 6—i.e. retrieving cloud computing access control credentials associated with each dedicated resource within the second set of dedicated resources.

Dedicated resource sharing platform 118 also includes a cloud computing platform management system interface 1190. Cloud computing platform management system interface 1190 is a processor implemented interface that is configured to interface with cloud computing platform 102 and/or with cloud computing platform management system for implementing a part or whole of method step 610 of FIG. 6—i.e. for partly or wholly implementing the step of initiating instantiation of a virtual machine(s) or a cloud computing session(s) or other cloud based or virtual resource(s) based on dedicated resources within the second set of dedicated resources (i) wherein said virtual machine(s) or cloud computing cloud computing session(s) or other cloud based or virtual resource(s) is instantiated for delivery of one or more cloud computing service(s) to the requesting resource user, and/or (ii) wherein the step of initiating said instantiation includes transmitting from the dedicated resource sharing platform to the computing platform, a request for initiating cloud based delivery of services from the second set of dedicated resources to the requesting resource user, and/or (iii) wherein the transmitted request includes (a) identifier data identifying the second set of dedicated resources, (b) the retrieved cloud computing access control credentials associated with each dedicated resource within the second set of dedicated resources, and (c) the defined period of time.

Dedicated resource sharing platform 118 may also include a pricing controller 1192 that comprises a processor implemented controller configured to negotiate a price for accessing dedicated shared resources through dedicated resource sharing platform 118, and for enabling a resource user that is accessing such shared resources to pay for the accessed resources.

The invention provides a computer implemented method for resource management for on-demand cloud computing. In an embodiment, the method comprises the steps of (i) receiving at a resource sharing platform, a request for providing to a first resource user, access to a first set of cloud computing hardware devices for communication network based delivery of at least one cloud computing service to the first resource user, wherein the request received at the resource sharing platform includes (a) a first set of hardware resource attributes that are required in the first set of cloud computing hardware devices, and (b) a first defined period of time for which access to the first set of cloud computing hardware devices is requested, (ii) parsing data records that are retrievably stored by the resource sharing platform, and that correspond to a second set of cloud computing hardware devices, wherein each hardware device within the second set of cloud computing hardware devices (c) is controllable by a cloud computing platform for instantiating or operating one or more virtual machine processes for communication network based delivery of one or more cloud computing services, (d) is reserved for exclusive use by a dedicated capacity resource user, for a second defined period of time, wherein the dedicated capacity resource user is distinct from the first resource user, and (e) is identified within at least one data record within the data records that are retrievably stored by the resource sharing platform, as being available for access by resource users other than the dedicated capacity resource user, within a third defined period of time that is a sub-set of the second defined period of time, (iii) identifying based on the parsed data records, a matched set of cloud computing hardware devices that is a sub-set of the second set of cloud computing hardware devices, wherein (f) hardware resource attributes of the matched set of cloud computing hardware devices match the first set of hardware resource attributes identified in the request received at the resource sharing platform, and (g) for each hardware device within the matched set of cloud computing hardware devices, at least part of the first defined period of time identified in the request received at the resource sharing platform falls within the third defined period of time during which said hardware device has been identified as being available for access by resource users other than the dedicated capacity resource user corresponding to said hardware device, (iv) retrieving cloud computing access control credentials associated with each hardware device within the matched set of cloud computing hardware devices, wherein said cloud computing access control credentials enable access to said hardware device through the cloud computing platform, and (v) delivering to the first resource user over the communication network, the at least one cloud computing service, wherein delivery of the at least one cloud computing service includes (h) instantiating or operating at least one virtual machine process on the matched set of cloud computing hardware devices, and (i) transmitting output from the at least one virtual machine process to a receiving computing device associated with the first resource user.

In an embodiment of the method, the first defined period of time identified in the request received at the resource sharing platform falls entirely within the third defined period of time during which said hardware device has been identified as being available for access by resource users other than the dedicated capacity resource user corresponding to said hardware device.

In another embodiment of the method, the request received at the resource sharing platform is transmitted to the resource sharing platform (i) from the receiving computing device associated with the first resource user, or (ii) from the cloud computing platform.

In a further embodiment of the method, the request received at the resource sharing platform is transmitted to the resource sharing platform from the cloud computing platform in response to a determination that a set of computing devices that are available for allocation by the cloud computing platform are insufficient for providing the first resource user with access to the first set of cloud computing hardware devices.

In another method embodiment, (i) instantiating the at least one virtual machine process on the matched set of cloud computing hardware devices includes the step of transmitting from the resource sharing platform to the cloud computing platform, a request for initiating delivery of the at least one cloud computing service to the first resource user over the communication network, and (ii) the transmitted request for initiating delivery of the at least one cloud computing service to the first resource user over the communication network includes one or more of (a) identifier data identifying the matched set of cloud computing devices, (b) the cloud computing access control credentials associated with each hardware device within the matched set of cloud computing hardware devices, and (c) the first defined period of time.

The invention additionally provides a system for resource management for on-demand cloud computing. The system comprises a memory, and a processor implemented resource sharing platform, configured for (i) receiving at a resource sharing platform, a request for providing to a first resource user, access to a first set of cloud computing hardware devices for communication network based delivery of at least one cloud computing service to the first resource user, wherein the request received at the resource sharing platform includes (a) a first set of hardware resource attributes that are required in the first set of cloud computing hardware devices, and (b) a first defined period of time for which access to the first set of cloud computing hardware devices is requested, (ii) parsing data records that are retrievably stored by the resource sharing platform, and that correspond to a second set of cloud computing hardware devices, wherein each hardware device within the second set of cloud computing hardware devices (c) is controllable by a cloud computing platform for instantiating or operating one or more virtual machine processes for communication network based delivery of one or more cloud computing services, (d) is reserved for exclusive use by a dedicated capacity resource user, for a second defined period of time, wherein the dedicated capacity resource user is distinct from the first resource user, and (e) is identified within at least one data record within the data records that are retrievably stored by the resource sharing platform, as being available for access by resource users other than the dedicated capacity resource user, within a third defined period of time that is a sub-set of the second defined period of time, (iii) identifying based on the parsed data records, a matched set of cloud computing hardware devices that is a sub-set of the second set of cloud computing hardware devices, wherein (f) hardware resource attributes of the matched set of cloud computing hardware devices match the first set of hardware resource attributes identified in the request received at the resource sharing platform, and (g) for each hardware device within the matched set of cloud computing hardware devices, at least part of the first defined period of time identified in the request received at the resource sharing platform falls within the third defined period of time during which said hardware device has been identified as being available for access by resource users other than the dedicated capacity resource user corresponding to said hardware device, (iv) retrieving cloud computing access control credentials associated with each hardware device within the matched set of cloud computing hardware devices, wherein said cloud computing access control credentials enable access to said hardware device through the cloud computing platform, and (v) delivering to the first resource user over the communication network, the at least one cloud computing service, wherein delivery of the at least one cloud computing service includes (h) instantiating or operating at least one virtual machine process on the matched set of cloud computing hardware devices, and (i) transmitting output from the at least one virtual machine process to a receiving computing device associated with the first resource user.

In an embodiment of the system, the first defined period of time identified in the request received at the resource sharing platform falls entirely within the third defined period of time during which said hardware device has been identified as being available for access by resource users other than the dedicated capacity resource user corresponding to said hardware device.

In another embodiment of the system, the request received at the resource sharing platform is transmitted to the resource sharing platform (i) from the receiving computing device associated with the first resource user, or (ii) from the cloud computing platform.

In a further embodiment of the system, the request received at the resource sharing platform is transmitted to the resource sharing platform from the cloud computing platform in response to a determination that a set of computing devices that are available for allocation by the cloud computing platform are insufficient for providing the first resource user with access to the first set of cloud computing hardware devices.

In another system embodiment, (i) instantiating the at least one virtual machine process on the matched set of cloud computing hardware devices includes the step of transmitting from the resource sharing platform to the cloud computing platform, a request for initiating delivery of the at least one cloud computing service to the first resource user over the communication network, and (ii) the transmitted request for initiating delivery of the at least one cloud computing service to the first resource user over the communication network includes one or more of (a) identifier data identifying the matched set of cloud computing devices, (b) the cloud computing access control credentials associated with each hardware device within the matched set of cloud computing hardware devices, and (c) the first defined period of time.

The invention additionally provides a computer program product for resource management for on-demand cloud computing. The computer program product comprises a non-transitory computer readable medium having a computer readable program code embodied therein, the computer readable program code comprising instructions for implementing the steps of (i) receiving at a resource sharing platform, a request for providing to a first resource user, access to a first set of cloud computing hardware devices for communication network based delivery of at least one cloud computing service to the first resource user, wherein the request received at the resource sharing platform includes (a) a first set of hardware resource attributes that are required in the first set of cloud computing hardware devices, and (b) a first defined period of time for which access to the first set of cloud computing hardware devices is requested, (ii) parsing data records that are retrievably stored by the resource sharing platform, and that correspond to a second set of cloud computing hardware devices, wherein each hardware device within the second set of cloud computing hardware devices (c) is controllable by a cloud computing platform for instantiating or operating one or more virtual machine processes for communication network based delivery of one or more cloud computing services, (d) is reserved for exclusive use by a dedicated capacity resource user, for a second defined period of time, wherein the dedicated capacity resource user is distinct from the first resource user, and (e) is identified within at least one data record within the data records that are retrievably stored by the resource sharing platform, as being available for access by resource users other than the dedicated capacity resource user, within a third defined period of time that is a sub-set of the second defined period of time, (iii) identifying based on the parsed data records, a matched set of cloud computing hardware devices that is a sub-set of the second set of cloud computing hardware devices, wherein (f) hardware resource attributes of the matched set of cloud computing hardware devices match the first set of hardware resource attributes identified in the request received at the resource sharing platform, and (g) for each hardware device within the matched set of cloud computing hardware devices, at least part of the first defined period of time identified in the request received at the resource sharing platform falls within the third defined period of time during which said hardware device has been identified as being available for access by resource users other than the dedicated capacity resource user corresponding to said hardware device, (iv) retrieving cloud computing access control credentials associated with each hardware device within the matched set of cloud computing hardware devices, wherein said cloud computing access control credentials enable access to said hardware device through the cloud computing platform, and (v) delivering to the first resource user over the communication network, the at least one cloud computing service, wherein delivery of the at least one cloud computing service includes (h) instantiating or operating at least one virtual machine process on the matched set of cloud computing hardware devices, and (i) transmitting output from the at least one virtual machine process to a receiving computing device associated with the first resource user.

In an embodiment of the computer program product, the first defined period of time identified in the request received at the resource sharing platform falls entirely within the third defined period of time during which said hardware device has been identified as being available for access by resource users other than the dedicated capacity resource user corresponding to said hardware device.

In another embodiment of the computer program product, the request received at the resource sharing platform is transmitted to the resource sharing platform (i) from the receiving computing device associated with the first resource user, or (ii) from the cloud computing platform.

In a further embodiment of the computer program product, the request received at the resource sharing platform is transmitted to the resource sharing platform from the cloud computing platform in response to a determination that a set of computing devices that are available for allocation by the cloud computing platform are insufficient for providing the first resource user with access to the first set of cloud computing hardware devices.

In another computer program product embodiment, (i) instantiating the at least one virtual machine process on the matched set of cloud computing hardware devices includes the step of transmitting from the resource sharing platform to the cloud computing platform, a request for initiating delivery of the at least one cloud computing service to the first resource user over the communication network, and (ii) the transmitted request for initiating delivery of the at least one cloud computing service to the first resource user over the communication network includes one or more of (a) identifier data identifying the matched set of cloud computing devices, (b) the cloud computing access control credentials associated with each hardware device within the matched set of cloud computing hardware devices, and (c) the first defined period of time.

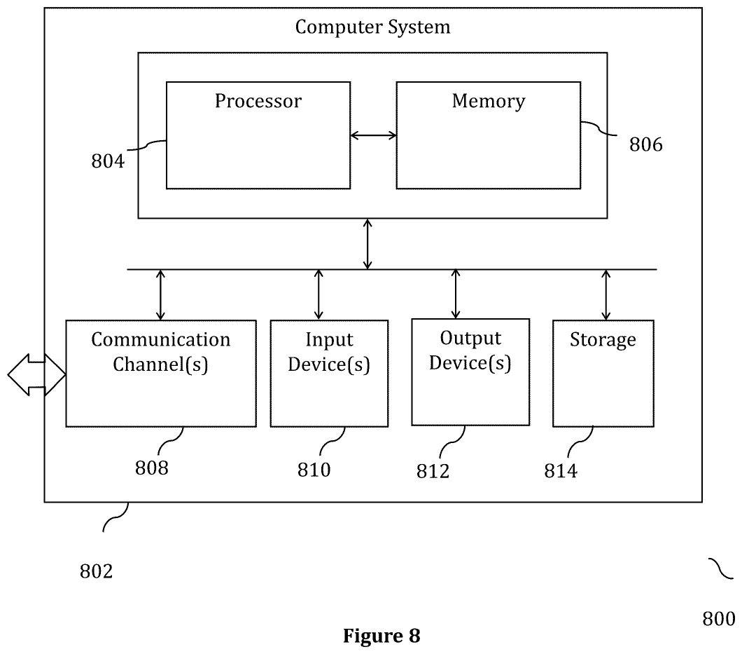

FIG. 8 illustrates an exemplary system 800 for implementing the present invention. The illustrated system 800 comprises computer system 802 which in turn comprises one or more processors 804 and at least one memory 806. Processor 804 is configured to execute program instructions—and may be a real processor or a virtual processor. It will be understood that computer system 802 does not suggest any limitation as to scope of use or functionality of described embodiments. The computer system 802 may include, but is not be limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 802 in accordance with the present invention may include one or more servers, desktops, laptops, tablets, smart phones, mobile phones, mobile communication devices, tablets, phablets and personal digital assistants. In an embodiment of the present invention, the memory 806 may store software for implementing various embodiments of the present invention. The computer system 802 may have additional components. For example, the computer system 802 may include one or more communication channels 808, one or more input devices 810, one or more output devices 812, and storage 814. An interconnection mechanism (not shown) such as a bus, controller, or network, interconnects the components of the computer system 802. In various embodiments of the present invention, operating system software (not shown) provides an operating environment for various softwares executing in the computer system 802 using a processor 804, and manages different functionalities of the components of the computer system 802.

The communication channel(s) 808 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 810 may include, but is not limited to, a touch screen, a keyboard, mouse, pen, joystick, trackball, a voice device, a scanning device, or any another device that is capable of providing input to the computer system 802. In an embodiment of the present invention, the input device(s) 810 may be a sound card or similar device that accepts audio input in analog or digital form. The output device(s) 812 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 802.

The storage 814 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 802. In various embodiments of the present invention, the storage 814 may contain program instructions for implementing any of the described embodiments.

In an embodiment of the present invention, the computer system 802 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 802. The method described herein is typically implemented as a computer program product, comprising a set of program instructions that is executed by the computer system 802 or any other similar device. The set of program instructions may be a series of computer readable codes stored on a tangible medium, such as a computer readable storage medium (storage 814), for example, diskette, CD-ROM, ROM, flash drives or hard disk, or transmittable to the computer system 802, via a modem or other interface device, over either a tangible medium, including but not limited to optical or analogue communications channel(s) 808. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

The invention accordingly provides a solution that enables identification and provision of on-demand computing resources in response to real-time demand at predictable pricing, and with a lower risk of a forced deallocation in situations where the hosted resources of a cloud computing platform are facing high demand/peak demand.

While the exemplary embodiments of the present invention are described and illustrated herein, it will be appreciated that they are merely illustrative. It will be understood by those skilled in the art that various modifications in form and detail may be made therein without departing from or offending the scope of the invention as defined by the appended claims. Additionally, the invention illustratively disclose herein suitably may be practiced in the absence of any element which is not specifically disclosed herein—and in a particular embodiment specifically contemplated, is intended to be practiced in the absence of any element which is not specifically disclosed herein.

We claim:

1. A computer implemented method for resource management for on-demand cloud computing, the method comprising the steps of:
receiving at a resource sharing platform, a request for providing to a first resource user, access to a first set of cloud computing hardware devices for communication network based delivery of at least one cloud computing service to the first resource user, wherein the request received at the resource sharing platform includes:
a first set of hardware resource attributes that are required in the first set of cloud computing hardware devices; and
a first defined period of time for which access to the first set of cloud computing hardware devices is requested;
parsing data records that are retrievably stored by the resource sharing platform, and that correspond to a second set of cloud computing hardware devices, wherein each hardware device within the second set of cloud computing hardware devices:
is controllable by a cloud computing platform for instantiating or operating one or more virtual machine processes for communication network based delivery of one or more cloud computing services;
is reserved for exclusive use by a dedicated capacity resource user, for a second defined period of time, wherein the dedicated capacity resource user is distinct from the first resource user; and
is identified within at least one data record within the data records that are retrievably stored by the resource sharing platform, as being available for access by resource users other than the dedicated capacity resource user, within a third defined period of time that is a sub-set of the second defined period of time;
identifying based on the parsed data records, a matched set of cloud computing hardware devices that is a sub-set of the second set of cloud computing hardware devices, wherein:
hardware resource attributes of the matched set of cloud computing hardware devices match the first set of hardware resource attributes identified in the request received at the resource sharing platform; and
for each hardware device within the matched set of cloud computing hardware devices, at least part of the first defined period of time identified in the request received at the resource sharing platform falls within the third defined period of time during which said hardware device has been identified as being available for access by resource users other than the dedicated capacity resource user corresponding to said hardware device;
retrieving cloud computing access control credentials associated with each hardware device within the matched set of cloud computing hardware devices, wherein said cloud computing access control credentials enable access to said hardware device through the cloud computing platform; and
delivering to the first resource user over the communication network, the at least one cloud computing service, wherein delivery of the at least one cloud computing service includes:
instantiating or operating at least one virtual machine process on the matched set of cloud computing hardware devices; and
transmitting output from the at least one virtual machine process to a receiving computing device associated with the first resource user.

2. The method as claimed in claim 1, wherein:
the first defined period of time identified in the request received at the resource sharing platform falls entirely within the third defined period of time during which said hardware device has been identified as being available for access by resource users other than the dedicated capacity resource user corresponding to said hardware device.

3. The method as claimed in claim 1, wherein the request received at the resource sharing platform is transmitted to the resource sharing platform:
from the receiving computing device associated with the first resource user; or
from the cloud computing platform.

4. The method as claimed in claim 3, wherein the request received at the resource sharing platform is transmitted to the resource sharing platform from the cloud computing platform in response to a determination that a set of computing devices that are available for allocation by the cloud computing platform are insufficient for providing the first resource user with access to the first set of cloud computing hardware devices.

5. The method as claimed in claim 1, wherein instantiating the at least one virtual machine process on the matched set of cloud computing hardware devices includes the step of transmitting from the resource sharing platform to the cloud computing platform, a request for initiating delivery of the at least one cloud computing service to the first resource user over the communication network; and
the transmitted request for initiating delivery of the at least one cloud computing service to the first resource user over the communication network includes one or more of:
identifier data identifying the matched set of cloud computing devices;
the cloud computing access control credentials associated with each hardware device within the matched set of cloud computing hardware devices; and
the first defined period of time.

6. A system for resource management for on-demand cloud computing, the system comprising:
a memory; and
a processor implemented resource sharing platform, configured for:
receiving a request for providing to a first resource user, access to a first set of cloud computing hardware devices for communication network based delivery of at least one cloud computing service to the first resource user, wherein the request received at the resource sharing platform includes:
a first set of hardware resource attributes that are required in the first set of cloud computing hardware devices; and
a first defined period of time for which access to the first set of cloud computing hardware devices is requested;
parsing data records that are retrievably stored by the resource sharing platform, and that correspond to a second set of cloud computing hardware devices, wherein each hardware device within the second set of cloud computing hardware devices:
is controllable by a cloud computing platform for instantiating or operating one or more virtual machine processes for communication network based delivery of one or more cloud computing services;
is reserved for exclusive use by a dedicated capacity resource user, for a second defined period of time, wherein the dedicated capacity resource user is distinct from the first resource user; and
is identified within at least one data record within the data records that are retrievably stored by the resource sharing platform, as being available for access by resource users other than the dedicated capacity resource user, within a third defined period of time that is a sub-set of the second defined period of time;
identifying based on the parsed data records, a matched set of cloud computing hardware devices that is a sub-set of the second set of cloud computing hardware devices, wherein:
hardware resource attributes of the matched set of cloud computing hardware devices match the first set of hardware resource attributes identified in the request received at the resource sharing platform; and
for each hardware device within the matched set of cloud computing hardware devices, at least part of the first defined period of time identified in the request received at the resource sharing platform falls within the third defined period of time during which said hardware device has been identified as being available for access by resource users other than the dedicated capacity resource user corresponding to said hardware device;
retrieving cloud computing access control credentials associated with each hardware device within the matched set of cloud computing hardware devices, wherein said cloud computing access control credentials enable access to said hardware device through the cloud computing platform; and
initiating delivery to the first resource user over the communication network, the at least one cloud computing service, wherein delivery of the at least one cloud computing service includes:
instantiating or operating at least one virtual machine process on the matched set of cloud computing hardware devices; and
transmitting output from the at least one virtual machine process to a receiving computing device associated with the first resource user.

7. The system as claimed in claim 6, wherein:
the first defined period of time identified in the request received at the resource sharing platform falls entirely within the third defined period of time during which said hardware device has been identified as being available for access by resource users other than the dedicated capacity resource user corresponding to said hardware device.

8. The system as claimed in claim 6, wherein the request received at the resource sharing platform is transmitted to the resource sharing platform:
from the receiving computing device associated with the first resource user; or
from the cloud computing platform.

9. The system as claimed in claim 8, wherein the request received at the resource sharing platform is transmitted to the resource sharing platform from the cloud computing platform in response to a determination that a set of computing devices that are available for allocation by the cloud computing platform are insufficient for providing the first resource user with access to the first set of cloud computing hardware devices.

10. The system as claimed in claim 6, wherein instantiating the at least one virtual machine process on the matched set of cloud computing hardware devices includes transmitting from the resource sharing platform to the cloud computing platform, a request for initiating delivery of the at least one cloud computing service to the first resource user over the communication network; and
the transmitted request for initiating delivery of the at least one cloud computing service to the first resource user over the communication network includes one or more of:
identifier data identifying the matched set of cloud computing devices;
the cloud computing access control credentials associated with each hardware device within the matched set of cloud computing hardware devices; and
the first defined period of time.

11. A computer program product for resource management for on-demand cloud computing, the computer program product comprising a non-transitory computer readable medium having a computer readable program code embodied therein, the computer readable program code comprising instructions for implementing the steps of:
receiving at a resource sharing platform, a request for providing to a first resource user, access to a first set of cloud computing hardware devices for communication network based delivery of at least one cloud computing service to the first resource user, wherein the request received at the resource sharing platform includes:
a first set of hardware resource attributes that are required in the first set of cloud computing hardware devices; and
a first defined period of time for which access to the first set of cloud computing hardware devices is requested;
parsing data records that are retrievably stored by the resource sharing platform, and that correspond to a second set of cloud computing hardware devices, wherein each hardware device within the second set of cloud computing hardware devices:
is controllable by a cloud computing platform for instantiating or operating one or more virtual machine processes for communication network based delivery of one or more cloud computing services;
is reserved for exclusive use by a dedicated capacity resource user, for a second defined period of time, wherein the dedicated capacity resource user is distinct from the first resource user; and
is identified within at least one data record within the data records that are retrievably stored by the resource sharing platform, as being available for access by resource users other than the dedicated capacity resource user, within a third defined period of time that is a sub-set of the second defined period of time;
identifying based on the parsed data records, a matched set of cloud computing hardware devices that is a sub-set of the second set of cloud computing hardware devices, wherein:
hardware resource attributes of the matched set of cloud computing hardware devices match the first set of hardware resource attributes identified in the request received at the resource sharing platform; and
for each hardware device within the matched set of cloud computing hardware devices, at least part of the first defined period of time identified in the request received at the resource sharing platform falls within the third defined period of time during which said hardware device has been identified as being available for access by resource users other than the dedicated capacity resource user corresponding to said hardware device;
retrieving cloud computing access control credentials associated with each hardware device within the matched set of cloud computing hardware devices, wherein said cloud computing access control credentials enable access to said hardware device through the cloud computing platform; and
delivering to the first resource user over the communication network, the at least one cloud computing service, wherein delivery of the at least one cloud computing service includes:
instantiating or operating at least one virtual machine process on the matched set of cloud computing hardware devices; and
transmitting output from the at least one virtual machine process to a receiving computing device associated with the first resource user.

12. The computer program product as claimed in claim 11, wherein:
the first defined period of time identified in the request received at the resource sharing platform falls entirely within the third defined period of time during which said hardware device has been identified as being available for access by resource users other than the dedicated capacity resource user corresponding to said hardware device.

13. The computer program product as claimed in claim 11, wherein the request received at the resource sharing platform is transmitted to the resource sharing platform:
from the receiving computing device associated with the first resource user; or
from the cloud computing platform.

14. The computer program product as claimed in claim 13, wherein the request received at the resource sharing platform is transmitted to the resource sharing platform from the cloud computing platform in response to a determination that a set of computing devices that are available for allocation by the cloud computing platform are insufficient for providing the first resource user with access to the first set of cloud computing hardware devices.

15. The computer program product as claimed in claim 11, wherein instantiating the at least one virtual machine process on the matched set of cloud computing hardware devices includes the step of transmitting from the resource sharing platform to the cloud computing platform, a request for initiating delivery of the at least one cloud computing service to the first resource user over the communication network; and
the transmitted request for initiating delivery of the at least one cloud computing service to the first resource user over the communication network includes one or more of:
identifier data identifying the matched set of cloud computing devices;
the cloud computing access control credentials associated with each hardware device within the matched set of cloud computing hardware devices; and
the first defined period of time.
